(19) United States
(12) Patent Application Publication
(10) Pub. No.: US 2009/0274562 A1
(43) Pub. Date: Nov. 5, 2009

(54) Coated turbine-stage nozzle segments

(75) Inventors: Michael J. Minor, Arlington, TX (US); Michael L. Miller, Euless, TX (US); Paul M. Pellet, Arlington, TX (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation, Hartford, CT (US)

(21) Appl. No.: 12/151,102

(22) Filed: May 2, 2008

(51) Int. Cl. F01D 5/14; B23P 6/00

(52) U.S. Cl. 416/241 R; 29/402.18; 416/241 B

(57) ABSTRACT

A method for coating a nozzle segment, the method comprising separating an outer shroud and an inner platform of the nozzle segment along pathways that bisect a first stator vane and a second stator vane of the of the nozzle segment, coating the first stator vane and the second stator vane after separating the outer shroud and the inner platform, and rejoining the separated outer shroud and the separated inner platform after coating the first stator vane and the second stator vane.

### BACKGROUND

The present invention relates to the manufacture and restoration of aerospace components, such as components of gas turbine engines. In particular, the present invention relates to methods for forming coatings on turbine-stage nozzle segments.

Gas turbine engines operate by burning a combustible fuel-air mixture, and converting the energy of combustion into a propulsive force. A gas turbine engine typically includes an inlet, a compressor, a combustor, a turbine, and an exhaust duct, where the compressor draws in ambient air and increases its temperature and pressure. Fuel is added to the compressed air in the combustor, where it is burned to raise the gas temperature, thereby imparting energy to the gas stream. The resulting combustion gases are directed axially rearward from the combustor through an annular duct, where the gases interact with multiple turbine stages disposed within the annular duct.

Each turbine stage includes a stationary turbine nozzle derived of multiple stator vanes, and a downstream row of rotatable blades. The stator vanes direct the combustion gases axially rearward in a downstream direction, and the rotatable blades direct the energy of the combustion gases to an axial drive shaft that is interconnected with the compressor. Stator vanes typically have airfoil geometries designated by concave pressure sides and convex suction sides that extend axially between corresponding leading and trailing edges of the airfoils. Each airfoil is also typically disposed circumferentially between an outer arcuate shroud and an inner arcuate platform, thereby forming a nozzle segment. Multiple nozzle segments are interconnected to form the annular ring of the stationary turbine nozzle. Each nozzle segment may be cast to include one or more stator vanes disposed between the same outer arcuate shroud and inner arcuate platform. For example, a nozzle segment containing a single stator vane is typically referred to as a nozzle singlet, a nozzle segment containing two stator vanes is typically referred to as a nozzle doublet, nozzle segment containing three stator vanes is typically referred to as a nozzle triplet, and so on.

The components of the turbine stages (e.g., vanes and blades) are required to be able to withstand the thermal and oxidation conditions of the high temperature combustion gas during the course of operation. To protect turbine engine components from the extreme conditions, such components are typically coated with metallic bond coats that provide oxidation and/or corrosion resistance, and with ceramic thermal barrier coatings to provide thermal protection. However, many coating processes for forming bond coats and thermal barrier coatings require line-of-sight depositions. This poses problems when coating nozzle segments having multiple stator vanes because the inboard surfaces of the stator vanes are partially shadowed from the line-of-sight depositions. The resulting coatings typically have high variations in coating thicknesses due to the partial shadowing. Thus, there is an ongoing need for methods for coating nozzle segments having multiple stator vanes (e.g., nozzle doublets and triplets) to provide substantially uniform coatings with line-of-sight coating techniques.

### SUMMARY

The present invention relates to a coated nozzle segment having a plurality of stator vanes disposed between an outer shroud and an inner platform, and a method for coating the nozzle segment. The method includes separating the outer shroud and the inner platform along pathways that bisect first and second vanes of the plurality of stator vanes, coating the first and the second vanes after separating the outer shroud and the inner platform, and rejoining each of the separated outer shroud and the separated inner platform after coating the first and the second vanes.

### BRIEF DESCRIPTION OF THE DRAWINGS

FIG. 1 is a flow diagram of a method for coating a nozzle segment having multiple stator vanes.

FIG. 2 is a top perspective view of a nozzle segment having multiple stator vanes disposed between an outer shroud and an inner platform.

FIG. 3 is a perspective view of the nozzle segment after separating the outer shroud and the inner platform.

FIG. 4 is a perspective view of the nozzle segment after rejoining the separated outer shroud and the separated inner platform.

### DETAILED DESCRIPTION

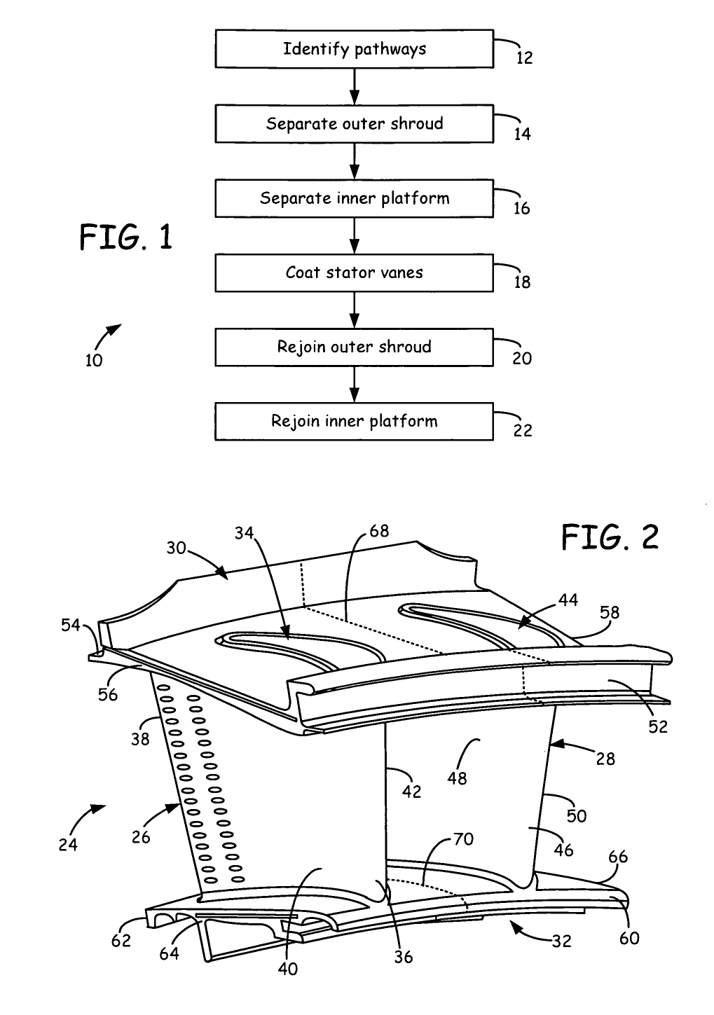

FIG. 1 is a flow diagram of method 10 for coating a nozzle segment having multiple stator vanes disposed between an outer shroud and an inner platform (e.g., nozzle doublets and triplets). As shown, method 10 includes steps 12-22, and initially involves identifying pathways along the outer shroud and the inner platform that bisect the stator vanes (step 12). The outer shroud and the inner platform are then separated along the identified pathways (steps 14 and 16) using a suitable separation technique (e.g., wire electrical discharge machining). The separation of the outer shroud and the inner platform splits the nozzle segment into multiple sub-segments, where each sub-segment desirably includes one of the multiple stator vanes. For example, in a nozzle doublet, the separation of the outer shroud and the inner platform splits the nozzle doublet into a pair of sub-segments, where each sub-segment includes a stator vane disposed between a portion of the outer shroud and a portion of the inner platform.

After the outer shroud and the inner platform are each separated, the stator vanes of the sub-segments are coated using a variety of coating techniques to form one or more coatings on the exposed surfaces of the stator vanes (step 18). Suitable coatings for the stator vanes include metallic protective coats (e.g., bond coats), thermal barrier coatings, and combinations thereof. As discussed below, the separation of the outer shroud and the inner platform allows the stator vanes to be placed apart from each other during the coating process, thereby allowing each stator vane to be coated with a line-of-sight coating technique. In one embodiment, this allows the resulting coatings to have substantially uniform thicknesses. As used herein with reference to a coating on a surface, the term “substantially uniform thickness” refers to coating thicknesses along the surface (e.g., along a surface of a stator vane) that remain within 10% of an average coating thickness for the given coating on the surface, disregarding thickness deviations due to topographical variations in the surface (e.g., cooling holes in the surface). Alternatively, in embodiments in which an non-uniform coating thickness is desirable (e.g., controlled changes in thickness), the separation of the outer shroud and the inner platform allow each stator vane to be coated with the desired changes in coating thicknesses.

After the coating process is complete, the outer shroud and the inner platform are each rejoined using a suitable joining process. The joining process forms bond lines between the sub-segments that are desirably capable of withstanding the extreme temperatures and pressures of the turbine stages of a gas turbine engine. The joining process also desirably preserves the integrities of the previously applied coatings (steps 20 and 22). The resulting nozzle segment, having the coated stator vanes, may then be reassembled with additional nozzle segments to form an annular ring of a stationary turbine nozzle. As discussed below, the separation and rejoining of the outer shroud and the inner platform allows the coatings formed on the stator vanes to have substantially uniformly thicknesses, thereby preserving the oxidation, corrosion, and/or thermal resistances of the stator vanes during the course of operation in a gas turbine engine.

FIGS. 2-4 are top perspective views of nozzle segment 24, which illustrate the use of method 10 (shown in FIG. 1) to form coatings on multiple stator vanes of nozzle segment 24. As shown in FIG. 2, nozzle segment 24 is a nozzle doublet that includes vanes 26 and 28, shroud 30, and platform 32. Vanes 26 are 28 are turbine-stage stator vanes secured between shroud 30 and platform 32. Vane 26 includes interior region 34, leading edge 36, trailing edge 38, pressure sidewall 40, and suction sidewall 42, where interior region 34 is a hollow interior portion of vane 26 that directs the flow of cooling air during operation. Pressure sidewall 40 is the concave pressure side of vane 26, which extends between leading edge 36 and trailing edge 38. Correspondingly, suction sidewall 42 is the convex suction side of vane 26, which also extends between leading edge 36 and trailing edge 38, and is the opposing surface to pressure sidewall 40.

Similarly, vane 28 includes interior region 44, leading edge 46, pressure sidewall 48, and suction sidewall 50, where interior region 44 is a hollow interior portion of vane 28 that directs the flow of cooling air during operation. Stator vane 28 also includes a trailing edge (not shown in FIG. 2) that corresponds to trailing edge 38 of stator vane 26. Pressure sidewall 48 is the concave pressure side of vane 28, which extends between leading edge 46 and the trailing edge of vane 28. Correspondingly, suction sidewall 50 is the convex suction side of vane 28, which also extends between leading edge 46 and the trailing edge of vane 28, and is the opposing surface to pressure sidewall 46.

Shroud 30 is an outer arcuate band secured to vanes 26 and 28, thereby allowing cooling air to enter interior regions 34 and 44 during operation. Shroud 30 includes leading edge 52, trailing edge 54, pressure side edge 56, and suction side edge 58, where leading edge 52 and trailing edge 54 are the upstream and downstream edges of shroud 30, respectively. Pressure side edge 56 and suction side edge 58 are the lateral edges of shroud 30, and are the edges that are secured to outer shrouds of adjacent nozzle segments (not shown) with leaf seal engagements to form a stationary turbine nozzle.

Correspondingly, platform 32 is an inner arcuate band secured to vanes 26 and 28, opposite of shroud 30. Platform 32 includes leading edge 60, trailing edge 62, pressure side edge 64, and suction side edge 66, where leading edge 60 and trailing edge 62 are the upstream and downstream edges of platform 32, respectively. Pressure side edge 64 and suction side edge 64 are the lateral edges of platform 32, and are the edges that are secured to inner platforms of adjacent nozzle segments (not shown) with leaf seal engagements to form the stationary turbine nozzle.

As shown, pressure sidewall 40 of vane 26 and suction sidewall 50 of vane 28 are outboard surfaces that are directly accessible with a line-of-sight coating technique. As a result, coatings may be readily deposited on pressure sidewall 40 and suction sidewall 50 with substantially uniform thicknesses. In contrast, however, suction sidewall 42 of vane 26 and pressure sidewall 48 of vane 28 are inboard surfaces, which partially shadow each other. The partial shadowing prevents line-of-sight coating techniques from evenly depositing coatings on suction sidewall 42 and pressure sidewall 48, thereby reducing coating thickness uniformity. The reduction in coating thickness uniformity correspondingly reduces the effectiveness of the formed coatings in providing corrosion, oxidation, and/or thermal resistance during the course of operation in a gas turbine engine.

As discussed above, method 10 is suitable for forming coatings on vanes 26 and 28, where the formed coatings have substantially uniform thicknesses on the outboard surfaces and the inboard surfaces. Prior to performing the coating process, pursuant to step 12 of method 10, pathways 68 and 70 are identified along shroud 30 and platform 32, respectively. Pathway 68 desirably extends from leading edge 52 to trailing edge 54 of shroud 30, between vanes 26 and 28. Similarly, pathway 70 desirably extends from leading edge 60 to trailing edge 62 of platform 32, also between vanes 26 and 28. As such, pathways 68 and 70 bisect vanes 26 and 28 along shroud 30 and shroud 32, respectively. While shown as linear pathways, pathways 68 and 70 may alternatively be non-linear pathways (e.g., curved lines and angled-segmented lines).

In one embodiment, pathways 68 and 70 are identified at locations along shroud 30 and platform 32 that are substantially even between vanes 26 and 28. This reduces the risk of damaging vanes 26 and 28 during the separation and rejoining steps of method 10. In an additional embodiment in which nozzle segment 24 includes existing bonds lines between vanes 26 and 28 (e.g., obtained during a previous manufacturing or restoration joining process), pathways 68 and 70 desirably follow the existing bond lines. This allows shroud 30 and platform 32 to be separated along the existing bond lines, which preserves the alloy microstructures of shroud 30 and platform 32.

After pathways 68 and 70 are identified, shroud 30 and platform 32 are separated along pathways 68 and 70, pursuant to steps 14 and 16 of method 10. Shroud 30 and platform 32 may be separated using a variety of techniques that are suitable for cutting the alloys of shroud 30 and platform 32 without damaging vanes 26 and 28. In one embodiment, shroud 30 and platform 32 are separated (simultaneously or sequentially) using wire electrical discharge machining (EDM). In this embodiment, nozzle segment 22 is placed in an aqueous bath, and a conductive wire is aligned with pathways 68 and 60 at leading edges 52 and 60, or at trailing edges 54 and 62. Electrical discharges are then sent through the conductive wire, thereby vaporizing successive portions of shroud 30 and platform 32 in the vicinity of the conductive wire. The wire is then passed along pathways 68 and 70 to separate nozzle segment 22 into separate sub-segments, thereby bisecting vanes 26 and 28.

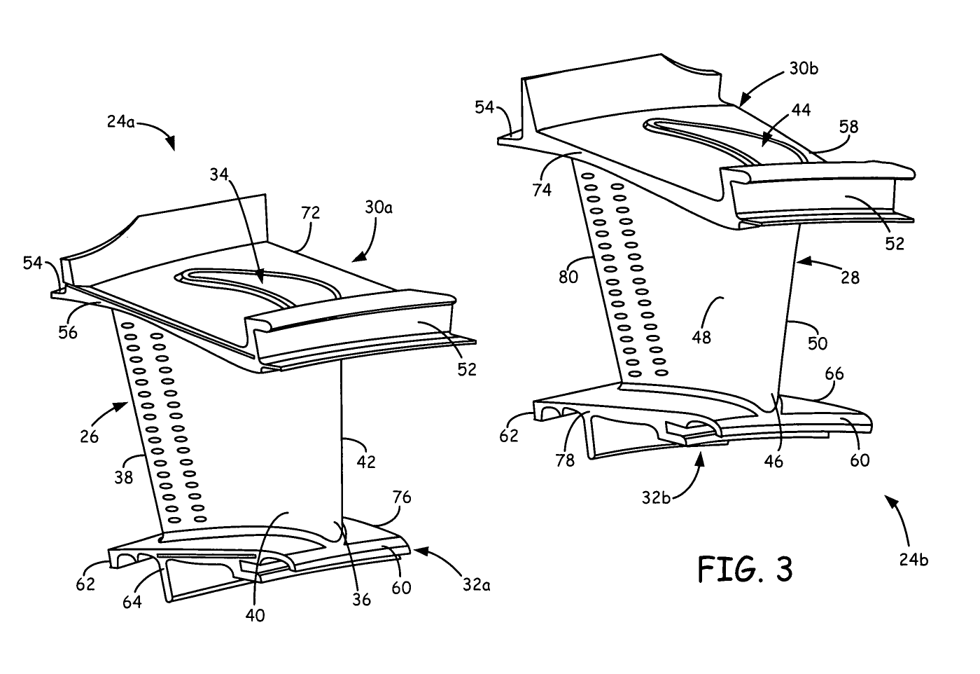

FIG. 3 shows nozzle segment 24 (shown in FIG. 2) separated into sub-segments 24a and 24b, where sub-segment 24a includes vane 26 disposed between shroud portion 30a and platform portion 32a, and sub-segment 24b includes vane 28 disposed between shroud portion 30b and platform portion 32b. Shroud portions 30a and 30b are the separated portions of shroud 30 (shown in FIG. 2), and respectively include split edges 72 and 74 formed along pathway 68 (shown in FIG. 2) during the separation process of step 14 of method 10. Correspondingly, platform portions 32a and 32b are the separated portions of platform 32 (shown in FIG. 2), and respectively include split edges 76 and 78 formed along pathway 70 (shown in FIG. 2) during the separation process of step 16 of method 10. As further shown in FIG. 3, vane 28 includes trailing edge 80, which is the trailing edge of vane 28, as discussed above.

After the separation process, sub-segments 24a and 24b are placed apart from each other, and vanes 26 and 28 are coated to form one or more protective coatings, pursuant to step 18 of method 10. Prior to the coating process, one or more surfaces of shroud portions 30a and 30b and platform portions 32a and 32b may be masked to prevent the formation of coatings on the masked surfaces. Vanes 26 and 28 may then be coated using a variety of coating techniques, including line-of-sight coating techniques. For metallic bond and protective coatings, suitable coating techniques include electron-beam physical vapor deposition, low-pressure plasma spraying, cathodic arc deposition, vapor phase aluminide coating, pack cementation, chemical vapor deposition, electroplating, and combinations thereof.

For example, in an electron-beam physical vapor deposition process, sub-segments 24a and 24b are each placed on a rotatable mount in a vacuum chamber containing a target anode derived of the desired coating material. A charged tungsten filament then emits an electron beam that contacts the target anode, thereby ionizing the material of the target anode. The ionized particles then precipitate onto pressure sidewall 40 and suction side wall 42 of vane 26 and onto pressure sidewall 48 and suction side wall 50 of vane 28 to form the desired metallic coatings. Examples of suitable materials for the metallic coatings include aluminum, platinum, MCrAlY alloys, combinations thereof. Examples of suitable average thicknesses for the metallic coatings on vanes 26 and 28 range from about 25 micrometers to about 200 micrometers, with particularly suitable thicknesses ranging from about 50 micrometers to about 100 micrometers.

The above-discussed coating processes may also be used to form thermal barrier coatings on vanes 26 and 28. Suitable materials for the thermal barrier coatings include zirconia-based materials, where the zirconia is desirably modified with a stabilizer to prevent the formation of a monoclinic phase, and pyrochlores. Examples of suitable stabilizers include yttria, gadolinia, calcia, ceria, magnesia, and combinations thereof. Examples of suitable coating thicknesses for the thermal barrier coatings on stator vanes 26 and 28 range from about 25 micrometers to about 1,000 micrometers, with particularly suitable coating thicknesses ranging from about 100 micrometers to about 500 micrometers.

As discussed above, separating sub-segments 24a and 24b allows vanes 26 and 28 to be coated without interference from each other. Thus, when separated, pressure sidewall 40 and suction side wall 42 of vane 26, and pressure sidewall 48 and suction side wall 50 of vane 28, are each outboard surfaces that are directly accessible to the deposited coating materials. Thus, the coatings formed on pressure sidewalls 40 and 48, and on suction side walls 42 and 50, may have substantially uniform thicknesses. This preserves the corrosion, oxidation, and/or thermal resistance of the coatings during the course of operation in a gas turbine engine.

After the coating process is completed, sub-segments are placed together such split edges 72 and 74 of shroud portions 30a and 30b are substantially aligned, and such that split edges 76 and 78 of platform portions 32a and 32b are substantially aligned. Accordingly, during the rejoining process, split edges 72, 74, 76, and 78 function as faying surfaces. Pursuant to steps 20 and 22 of method 10, shroud portions 30a and 30b, and platform portions 32a and 32b are then each rejoined to reform shroud 30 and platform 32, respectively. As discussed above, the rejoining process forms bond lines (not shown in FIG. 3) between sub-segments 24a and 24b that are desirably capable of withstanding the extreme temperatures and pressures of the turbine stages of a gas turbine engine. Suitable techniques for the joining process may include any process that produces a metallurgical bond, such as gas tungsten arc welding, electron beam welding, laser welding, brazing, diffusion brazing, transient liquid phase bonding, and combinations thereof.

In one embodiment the rejoining process involves thermal diffusion bonding. In this embodiment, split edges 72 and 74 are compressed together and are subjected to elevated temperatures to interdiffuse the materials of shroud portions 30a and 30b, and split edges 76 and 78 are compressed together and are subjected to elevated temperatures to interdiffuse the materials of platform portions 32a and 32b. This may be performed by compressing sub-segments 24a and 24b together at split edges 72 and 74 and at split edges 76 and 78, and placing the compressed sub-segments 24a/24b in a vacuum oven for a suitable temperature and duration to interdiffuse the materials.

Suitable temperatures and durations for the thermal diffusion bonding include those that sufficiently bond shroud portions 30a and 30b, that sufficiently bond platform portions 32a and 32b, and that also substantially preserve the integrities of the coatings applied to vanes 26 and 28. Examples of suitable temperatures for the thermal diffusion bonding range from about 1040° C. (about 1900° F.) to about 1200° C. (about 2200° F.), with particularly suitable temperatures ranging from about 1090° C. (about 2000° F.) to about 1150° C. (about 2100° F.). Examples of suitable durations for the thermal diffusion bonding include durations up to about one hour, with particularly suitable durations ranging from about 10 minutes to about 30 minutes.

In an alternative embodiment, the rejoining process involves a transient liquid phase bonding. In this embodiment, layers of one or more brazing materials are placed between split edges 72 and 74, and between split edges 76 and 78, and sub-segments 24a and 24b are subjected to elevated temperatures. The elevated temperatures liquefy the brazing materials, thereby allowing the liquefied brazing materials to interdiffuse with the alloys of sub-segments 24a and 24b. Suitable temperatures and durations for the transient liquid phase bonding include those discussed above for the thermal diffusion bonding.

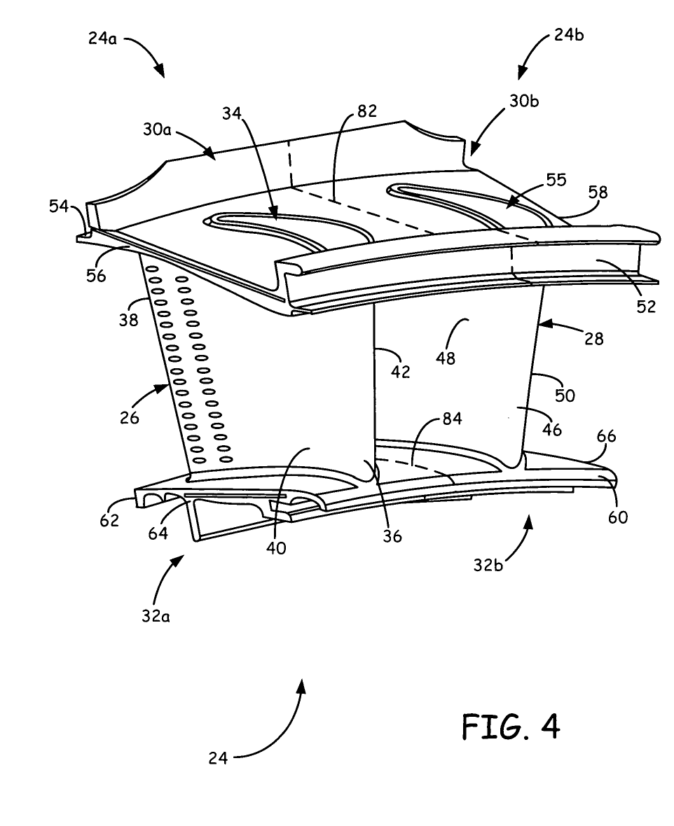

FIG. 4 shows sub-segments 24a and 24b rejoined at bond lines 82 and 84, thereby reforming nozzle segment 24 with coated vanes 26 and 28. Bond lines 82 and 84 are the locations of the interdiffused materials from the joining process, and generally follow pathways 68 and 70 (shown in FIG. 2), respectively. As discussed above, method 10 provides a suitable means for protecting vanes 26 and 28 with coatings having substantially uniform thicknesses, and is particularly suitable for use in combination with the restoration of used nozzle segments (e.g., nozzle segment 24). The resulting nozzle segment 24, having coated vanes 26 and 28, may then undergo one or more post-processing steps before being reassembled with additional nozzle segments to form an annular ring of a stationary turbine nozzle. The formed coatings may then protect vanes 26 and 28 from oxidation, corrosion, thermal attacks during the course of operation in a gas turbine engine.

Although the present invention has been described with reference to preferred embodiments, workers skilled in the art will recognize that changes may be made in form and detail without departing from the spirit and scope of the invention.

1. A method for coating a nozzle segment having a plurality of stator vanes disposed between an outer shroud and an inner platform, the method comprising:
separating the outer shroud and the inner platform along pathways that bisect a first stator vane and a second stator vane of the plurality of stator vanes;
coating the first stator vane and the second stator vane after separating the outer shroud and the inner platform;
rejoining the separated outer shroud after coating the first stator vane and the second stator vane; and
rejoining the separated inner platform after coating the first stator vane and the second stator vane.

2. The method of claim 1, wherein separating the outer shroud and the inner platform along the pathways comprises wire electrical discharge machining the outer shroud and the inner platform along the pathways.

3. The method of claim 1, wherein coating the first stator vane and the second stator vane comprises performing an electron-beam physical vapor deposition process on the first stator vane and on the second stator vane.

4. The method of claim 1, wherein the first stator vane and the second stator vane each comprise a pressure sidewall and a suction sidewall, wherein after coating the first stator vane and the second stator vane, each of the pressure sidewalls and each of the suction sidewalls comprises a coating having a substantially uniform thickness.

5. The method of claim 1, wherein rejoining the separated outer shroud and rejoining the separated inner platform comprise performing a heat treatment process.

6. The method of claim 5, wherein the heat treatment process is selected from the group consisting of thermal diffusion bonding and transient liquid phase bonding.

7. The method of claim 5, wherein the heat treatment process is performed at a temperature ranging from about 1040° C. to about 1200° C.

8. The method of claim 7, wherein the temperature of the heat treatment process ranges from about 1090° C. to about 1150° C.

9. A method for coating a nozzle segment having a plurality of stator vanes disposed between an outer shroud and an inner platform, the method comprising:
identifying a first pathway along the outer shroud that bisects a first stator vane and a second stator vane of the plurality of stator vanes;
identifying a second pathway along the inner platform that bisects the first stator vane and the second stator vane;
separating the outer shroud along the identified first pathway to form a first shroud portion secured to the first stator vane and a second shroud portion secured to the second stator vane;
separating the inner platform along the identified second pathway to form a first platform portion secured to the first stator vane and a second platform portion secured to the second stator vane;
forming a first coating on the first stator vane after separating the outer shroud and the inner platform;
forming a second coating on the second stator vane after separating the outer shroud and the inner platform;
rejoining the first shroud portion and the second shroud portion; and
rejoining the first platform portion and the second platform portion.

10. The method of claim 9, wherein separating the outer shroud along the identified first pathway comprises wire electrical discharge machining the outer shroud along the identified first pathway.

11. The method of claim 10, wherein separating the inner platform along the identified second pathway comprises wire electrical discharge machining the inner platform along the identified second pathway.

12. The method of claim 9, wherein forming at least one of the first coating and the second coating comprises performing an electron-beam physical vapor deposition process.

13. The method of claim 9, wherein rejoining the first shroud portion and the second shroud portion, and rejoining the first platform portion and the second platform portion are performed in a heat treatment process.

14. The method of claim 13, wherein the heat treatment process is performed at a temperature ranging from about 1040° C. to about 1200° C.

15. A nozzle segment comprising:
a first stator vane comprising a first pressure sidewall and a first suction sidewall, wherein the first pressure sidewall and the first suction sidewall each comprise a first coating having a substantially uniform thickness;
a second stator vane comprising a second pressure sidewall and a second suction sidewall, wherein the second pressure sidewall and the second suction sidewall each comprise a second coating having a substantially uniform thickness;
an outer shroud secured to the first stator vane and the second stator vane, the outer shroud having a first bond line disposed between the first stator vane and the second stator vane, and formed after first coating and the second coating are formed; and
an inner platform secured to the first stator vane and the second stator vane at opposing ends from the outer shroud, the inner platform having a second bond line disposed between the first stator vane and the second stator vane, and formed after first coating and the second coating are formed.

16. The nozzle segment of claim 15, wherein the first coating and the second coating are each formed from at least one material selected from the group consisting of aluminum, platinum, MCrAlY alloys, ceramic materials, and combinations thereof.

17. The nozzle segment of claim 15, wherein the first coating and the second coating each comprises an electron beam physical vapor deposition coating.

18. The nozzle segment of claim 15, wherein the first bond line and the second bond line are each formed with a heat treatment process having a temperature ranging from about 1040° C. to about 1200° C.

19. The nozzle segment of claim 15, wherein the first coating and the second coating each have a coating thickness ranging from about 25 micrometers to about 1,000 micrometers.

20. The nozzle segment of claim 19, wherein the coating thickness ranges from about 25 micrometers to about 200 micrometers.
